(19) United States
(12) Patent Application Publication
(10) Pub. No.: US 2025/0214099 A1
(43) Pub. Date: Jul. 3, 2025

(54) GARDEN SPRINKLER PROTECTING RACK

(71) Applicant: SHIN TAI SPURT WATER OF THE GARDEN TOOLS CO., LTD, Lukang Township (TW)

(72) Inventor: Chin-Yuan Chen, Lukang Township (TW)

(21) Appl. No.: 18/402,673

(22) Filed: Jan. 2, 2024

(51) Int. Cl. B05B 15/16

(52) U.S. Cl. CPC B05B 15/16

(57) ABSTRACT

A garden sprinkler protecting rack is covered with a carbon fiber texture, the carbon fiber texture providing light reflection. The protecting rack is a hollow cone with a smaller top and a larger bottom, so that an interior of the protecting rack provides a stacking space. the protecting rack has a top portion with a flange having a through hole, and a lower portion of the protecting rack has a plurality of dividing openings which forms a respective supporting foot between each dividing opening.

### BACKGROUND OF INVENTION

### Field of Invention

The present invention relates to a garden sprinkler protecting rack.

### Description of Related Art

Generally, in order to save a lot of time and effort required for manual irrigation, large area gardening watering, such as lawn watering, is usually done with sprinklers. Most of the currently common sprinklers have a main body fixed on the ground, and the main body has a water inlet end and a water outlet end. The water inlet end is configured for being connected to a water source, then water is sent into the main body from the water inlet end, the water can be sprayed evenly from the water outlet end to the outer periphery of the sprinkler.

However, the above conventional structure still has the following problems in practical application: the sprinkler is usually buried under the ground, and only the water outlet end is exposed to the surface. However, this installation method often causes the sprinkler damaged due to people stepping on it or using hand push lawn mower or ride-on lawn mower to trim the lawn, resulting in a short usage life.

Therefore, it is desirable to provide a garden sprinkler protecting rack to mitigate and/or obviate the aforementioned problems.

### SUMMARY OF INVENTION

An objective of present invention is to provide a garden sprinkler protecting rack, which is capable of improving the above-mention problems.

In order to achieve the above mentioned objective, a garden sprinkler protecting rack is covered with a carbon fiber texture, the carbon fiber texture providing light reflection. The protecting rack is a hollow cone with a smaller top and a larger bottom, so that an interior of the protecting rack provides a stacking space. the protecting rack has a top portion with a flange having a through hole, and a lower portion of the protecting rack has a plurality of dividing openings which forms a respective supporting foot between each dividing opening.

Other objects, advantages, and novel features of invention will become more apparent from the following detailed description when taken in conjunction with the accompanying drawings.

### BRIEF DESCRIPTION OF DRAWINGS

FIG. 1 is a three-dimensional view of a preferred embodiment according to the present invention.

FIG. 2 is a cross-sectional view of the preferred embodiment according to the present invention.

FIG. 3 is a usage status drawing of the preferred embodiment according to the present invention.

FIG. 4 is a state drawings showing the refraction of light provided by the carbon fiber texture according to the present invention.

FIG. 5 is a state diagram of centralized stacking according to the present invention.

FIG. 6 is a state diagram of being used as an earth digging tool of the preferred embodiment according to the present invention.

FIG. 7: is a perspective view of another preferred embodiment of the present invention.

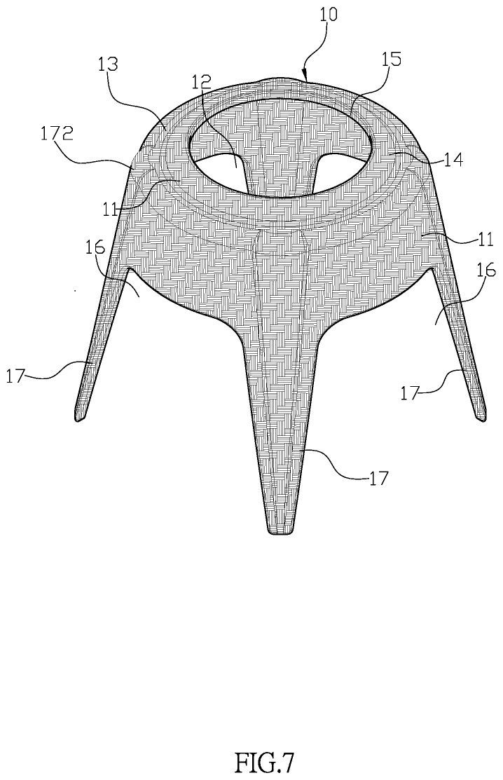

### DETAILED DESCRIPTION OF PREFERRED EMBODIMENT

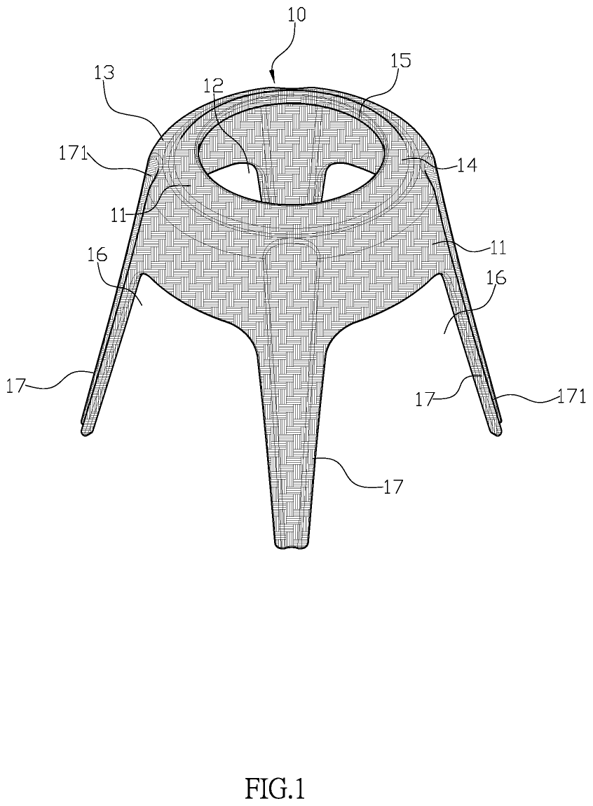

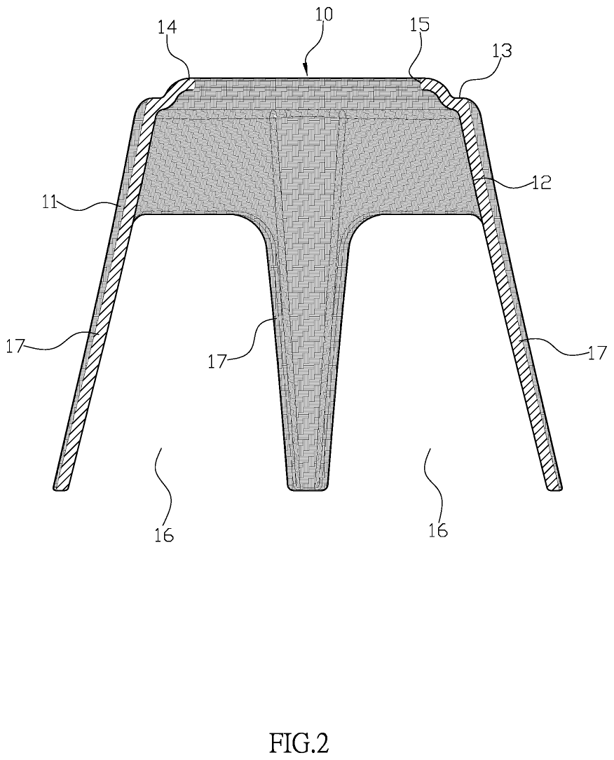

First, please refer to FIGS. 1 to 4. A garden sprinkler protecting rack is covered with a carbon fiber texture 11, and the carbon fiber texture 11 provides light reflection for light 30. Therefore, the protecting rack 10 can still be clearly seen under weak light sources such as moonlight and street lights, greatly improving the visibility in dim environments. With the carbon fiber texture 11 covering the surface of the protecting rack 10, the rack 10 can be more beautiful to enhance the overall texture of the protecting rack 10. The protecting rack 10 is a hollow cone with a smaller top and a larger bottom, so that an interior of the protecting rack provides a stacking space 12. The protecting rack 10 has a top portion 13 with a flange 14 having a through hole 15, and a lower portion of the protecting rack 10 has a plurality of dividing openings 16 which forms a respective supporting foot 17 between each dividing opening the flange 14.

Furthermore, the carbon fiber texture 11 is disposed on an outer surface of the protecting rack 10.

In addition, both an inner surface and an outer surface of the protecting rack 10 are covered by the carbon fiber texture 11.

Moreover, each supporting foot further 17 has an indentation for reinforcement 171.

Additionally, each supporting foot 17 further has a convex part 172 for reinforcement.

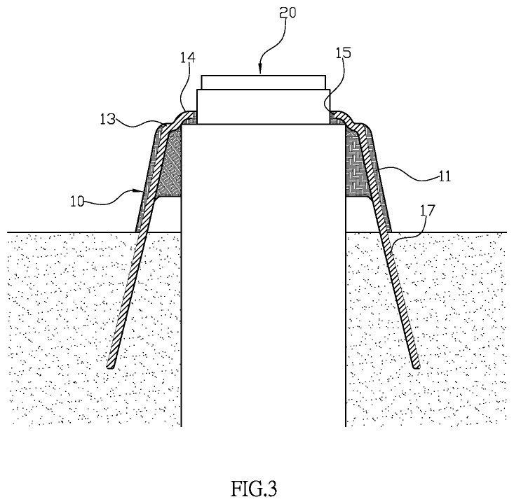

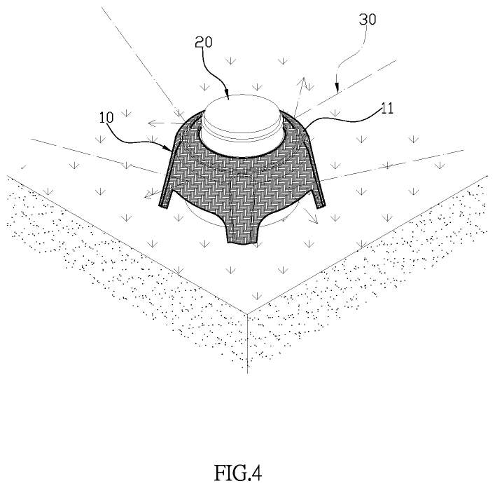

As shown in FIG. 3, For actual use, the supporting foot 17 is inserted into the soil on the ground, and the top 13 and the flange 14 are configured for positioning, so that the protecting rack 10 is capable of covering the gardening sprinkler 20 to protect the sprinkler 20 from collision. Utilizing the penetration of the through hole 15, the sprinkler 20 can also sprinkle water from the through hole 15 to the outer periphery. Furthermore, since the surface of the protecting rack 10 is covered with the carbon fiber texture 11, the light 30 is reflected by the carbon fiber texture 11, as shown in FIG. 4, and the protecting rack 10 is capable of still having a good visual effect at night.

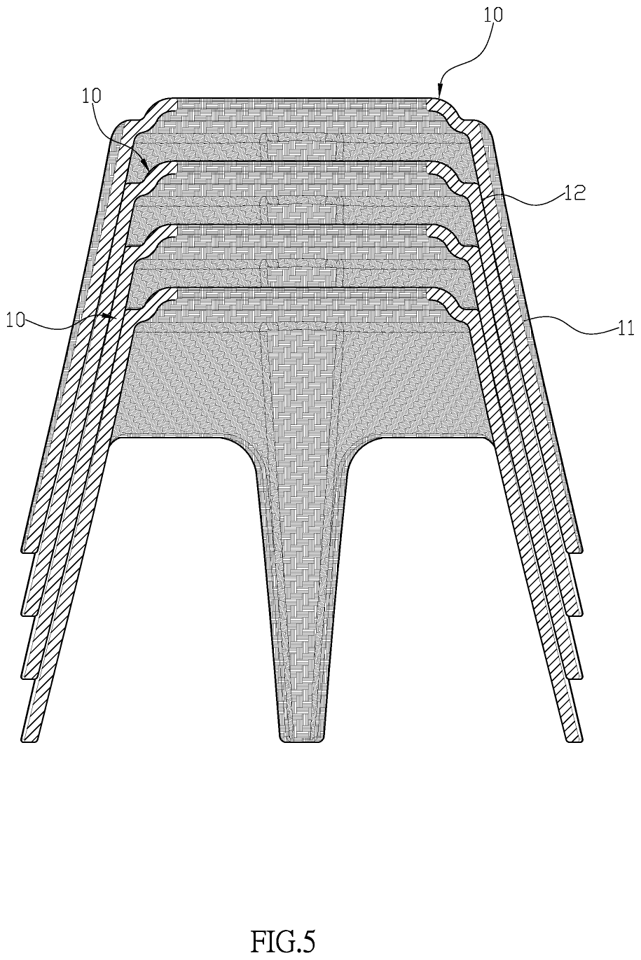

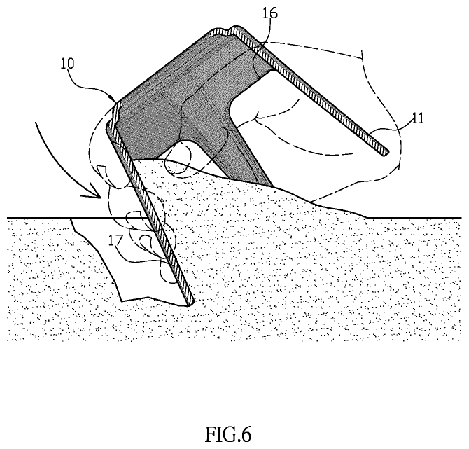

The above-mentioned garden sprinkler protecting rack has the following advantages: when the protecting rack 10 covers the sprinkler 20, the sprinkler 20 can be protected from collision, so as to avoid the sprinkler 20 being easily damaged in an accidental collision, which effectively extends the service life of the sprinkler 20. Since the surface of the protecting rack 10 is covered with the carbon fiber texture 11 capable of refracting the light 30, the protecting rack 10 can still have best visual effect and safe use. The protecting rack 10 is a hollow cone with a small top and a large bottom, and has a stacking space 12 inside, so that multiple protecting racks 10 can be stacked one by one from bottom to top as shown in FIG. 5, which saves space and volume in storage and packaging. Also, when you want to bury the sprinkler 20, if you don't have suitable items on hand for digging, the protecting rack can be used as a hand tool, as shown in FIG. 6.

Although the present invention has been explained in relation to its preferred embodiment, it is to be understood that many other possible modifications and variations can be made without departing from the spirit and scope of invention as hereinafter claimed.

What is claimed is:

1. A garden sprinkler protecting rack, wherein:
the protecting rack is covered with a carbon fiber texture, the carbon fiber texture providing light reflection; the protecting rack is a hollow cone with a smaller top and a larger bottom, so that an interior of the protecting rack provides a stacking space; the protecting rack has a top portion with a flange having a through hole, and a lower portion of the protecting rack has a plurality of dividing openings which forms a respective supporting foot between each dividing opening.

2. The garden sprinkler protecting rack as claimed in claim 1, wherein the carbon fiber texture is disposed on an outer surface of the protecting rack.

3. The garden sprinkler protecting rack as claimed in claim 1, wherein both an inner surface and an outer surface of the protecting rack are covered by the carbon fiber texture.

4. The garden sprinkler protecting rack as claimed in claim 1, wherein each supporting foot further has an indentation for reinforcement.

5. The garden sprinkler protecting rack as claimed in claim 1, wherein each supporting foot further has a convex part for reinforcement.
